(19) United States
(12) Patent Application Publication
(10) Pub. No.: US 2026/0092627 A1
(43) Pub. Date: Apr. 2, 2026

(54) METHOD AND SYSTEM FOR RETAINING BEARING DEBRIS IN COILED TUBING UNITS

(71) Applicant: Premier Coil Solutions, Inc., Waller, TX (US)

(72) Inventor: Randall Behrens, Waller, TX (US)

(21) Appl. No.: 19/344,871

(22) Filed: Sep. 30, 2025

Related U.S. Application Data
(60) Provisional application No. 63/701,212, filed on Sep. 30, 2024.

(51) Int. Cl. F16C 35/04; E21B 19/22; F16C 19/08; F16C 33/78

(52) U.S. Cl. CPC F16C 35/04; E21B 19/22; F16C 19/08; F16C 33/78

(57) ABSTRACT

A roller assembly for a coiled tubing guide assembly has a roller having an interior; a shaft within the interior of the roller. The shaft is configured to attach to a coiled tubing guide assembly while allowing the roller to roll. One or more bearings are within the interior of the roller. A bearing retainer is configured to prevent bearing debris from leaving the roller interior. This prevents bearing debris from affecting or damaging other components of the coiled tubing unit.

### CROSS-REFERENCE TO RELATED APPLICATIONS

This application claims priority to U.S. Provisional Patent Application No. 63/701,212, entitled “Method and System for Retaining Bearing Debris in Coiled Tubing Units,” filed on Sep. 30, 2024. The entire disclosure of this priority application is incorporated herein by reference in its entirety.

### FIELD OF THE DISCLOSURE

The present disclosure relates to processes and systems for protecting a coiled tubing injector and other components from damage due to bearing debris.

### BACKGROUND AND SUMMARY

Coiled Tubing is a relatively new technology for the oil and gas industry. It is used for interventions in oil and gas wells and production tubing. Previous to the introduction of Coil Tubing, Wirelining was used to complete similar operations. The most common application is deliquification, and the dispersement of fluids to a specific location in the well. Coiled Tubing has recently been used to assist in drilling operations.

The Coiled tubing is feed from a reel into the injector which effectively powers the tubing into the wellhead. The end of the coiled tubing string can be outfitted with numerous downhole tools including drill bits and other related drilling equipment. The “Gooseneck” is the angled piece on the injector which guides the tubing and allows a bending of the coil string to allow it to go through the injector. It is what guides the tubing from the reel and directs the tubing from an upwards angle and turns it into a vertical down position into the injector and through a Blow-out Preventer (BOP) Stack into the Wellhead. The Injector and Gooseneck are connected together and are suspended by a crane or similar lifted methods for operations.

A coiled tubing injector head is the mechanism that pushes or pulls a string of continuous steel tubing in and out of an oil well. This mechanism has a plurality of moving parts interacting with each other and the tubing. A coiled tubing injector is lifted and held by a crane above the wellhead. Installed above the injector head is a tubing guide which provides a smooth transition for the upward trajectory of the tubing from the reel over and back downward into the top of the injector head. The tubing guide also has a plurality of moving parts which assist tubing movement into the injector head.

It is common for bearings to be pressed into a roller so that it can rotate on a fixed shaft. Unfortunately, tubing guide components, namely bearings in the guide rollers often may become damaged in normal operation. The access where the shaft, e.g., cotter pin, is installed also unfortunately leaves access for damaged bearing debris to easily fall out. The damaged bearing debris then pose a further risk of falling into the injector head or other components and causing subsequent damage. In this manner, the damaged bearings create debris that can then cause chain reaction failures. This is true for further damage within the same bearing or it can extend to other interacting components within a system. That is, a single point failure of a low cost component may cause a much wider scale of equipment damage. This damage can be costly in terms of equipment damage and loss of productivity due to down time. What is needed are systems and methods to prevent a damaged bearing from causing further damage to other components. It would further be beneficial if such systems and methods were cost-effective, relatively easy to install and use, and/or capable of being employed on both newly manufactured equipment, as well as retrofit to existing equipment. Advantageously, the systems and methods described herein may accomplish one or more up to all of the aforementioned needs.

Components can be installed to keep any damaged components or bearing debris retained within the rolling element assembly. A method of retention is developed to keep damaged bearing components from falling into the injector head. Equipment damage can be limited to the initial issue. In this manner, this invention limits resultant damage caused by a bearing failure

In one embodiment the application pertains to a roller assembly for a coiled tubing guide assembly. The roller assembly has roller having an interior and a shaft within the interior of the roller. The shaft is configured to attach to a coiled tubing guide assembly while allowing the roller to roll. One or more bearings are within the interior of the roller. A bearing retainer is configured to prevent bearing debris from leaving the roller interior. This prevents bearing debris from affecting or damaging other components of the coiled tubing unit.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows a coiled tubing unit with a tubing guide comprising the bearing retainer.

FIG. 2 shows a coiled tubing unit with a tubing guide comprising the bearing retainer.

FIG. 3 shows a tubing guide comprising the bearing retainer.

FIG. 4 shows the injector used with the tubing guide comprising the bearing retainer.

FIG. 5 shows a coiled tubing unit with a tubing guide comprising the bearing retainer.

FIG. 6 shows a tilting coiled tubing unit with a tubing guide comprising the bearing retainer.

FIG. 7 shows a coiled tubing path.

FIG. 8 shows a tubing guide comprising the bearing retainer.

FIG. 9A shows a V-roller with the bearing retainer inside.

FIG. 9B shows a cross-section of the V-roller of FIG. 9A with the bearing retainer.

### DETAILED DESCRIPTION

The following description of embodiments provides a non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

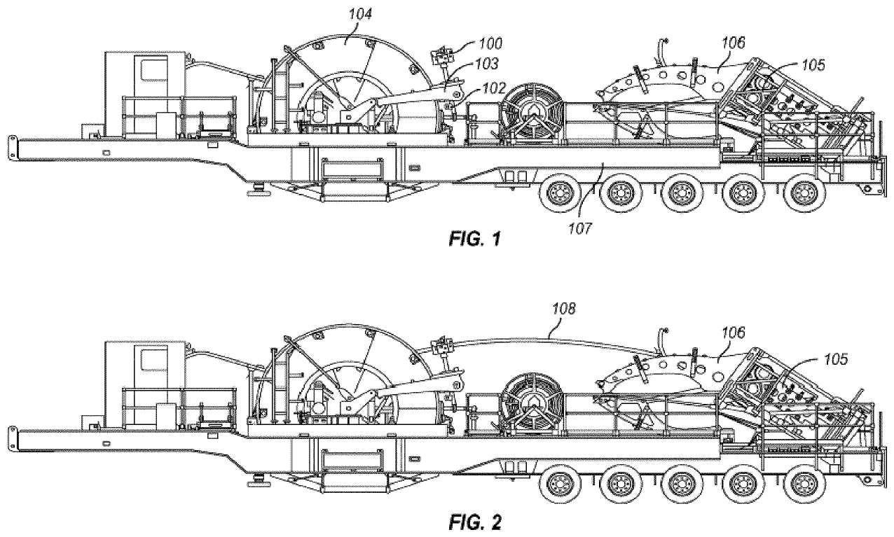

The methodology of preparing the unit for the impending work usually starts when new tubing is introduced as shown in FIG. 1 onto the tubing reel (104), and is re-routed through the tubing guide (106) with the bearing retainer into an injector (105) to begin operations. The coiled tubing is typically fed from a tubing reel (104) through a device called a counter (100) which counts the amount of tubing deployed into the wellhead. The counter may be supported by a telescoping rod (102) which can be configured to automatically adjust the height of the counter (100) by force from the height of the levelwind arm (103) which is usually controlled by the operator. The levelwind arm (103) is typically adjusted to provide a precise operating angle in which the tubing is deployed into a bending and straightening mechanism commonly called a tubing guide (106) and into an injector (105) which forces the tubing into the wellhead.

The height of the injector (105) as it lays on the trailer (107) is why the levelwind arm (103) is usually adjusted. That is, the adjustment is part of a method in which the injector is introduced to the tubing by an industry method called “stabbing” of the pipe into the injector.

The stabbing operation may be dangerous due to the fact that spooled tubing is a semi-flexible metal and is under tension. As such, it is usually released in a controlled manner to prevent unwanted unwrapping of the spool which could result in lashing tubing which creates a safety hazard. This precise operation combined with the fact that the pipe is typically in an unsupported state mean that the stabbing process should be controlled carefully. A variable that can reduce the stabbing time and associated risk is the distance between the reel and the injector.

The tubing is typically secured by a clamp near the counter (100) to prevent the tubing from going back through the counter and unspooling. Depending on the length of pipe that the tubing supplier provides on the other side of the counter (injector side 105), trimming the tubing (108) in FIG. 2 is normally done to properly “stab” pipe into the injector. If the tubing (108) is positioned too close to the injector, it may be cut to provide a proper sloping angle from the reel into the injector. The sloping or angled cut may also allow less blunt trauma on critical seals on the attachments below the injector (105) towards the wellhead. The reel (104) motor is then turned at a slow rate to allow humans to keep up while providing ample tension to the remaining thousands of feet of spooled tubing. This harmonized effort is completed by attaching a securement device to the tubing while attempting to maintain a safe approach angle to the tensioned reel (104) along the path towards the opening.

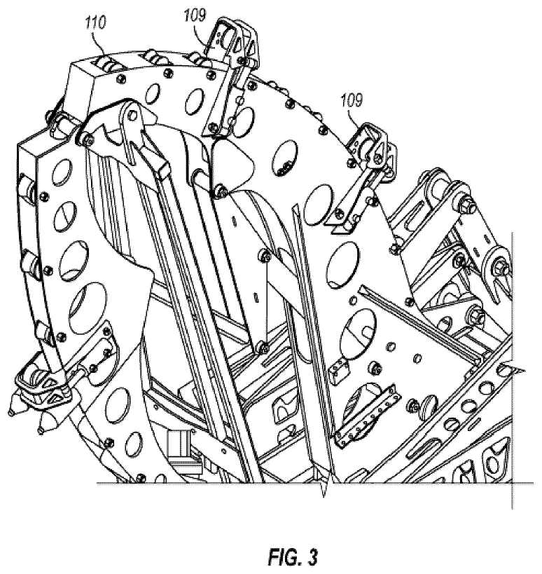

As shown in FIG. 3 the tubing may be pushed by the rollers (110) on the backside of the tubing guide (106). One or more rollers may comprise bearings and a bearing retainer for containing any bearing debris within the roller. Typically, the distance of the pipe that is needed is estimated by the operator and/or personnel on site.

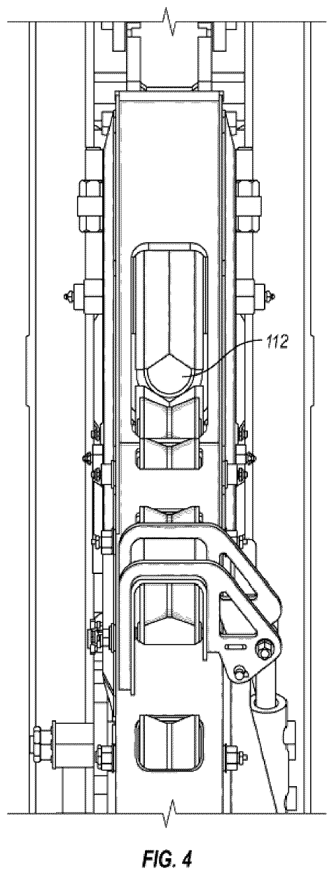

Securement of the spooled reel (104) and tubing (108) remains paramount throughout the “stabbing” procedure. Typically, the less amount of tubing that is deployed, the safer and more efficient the operation becomes. The tubing is forced down by gravity and the natural curve of the tubing, so the levelwind arm (103) is initially positioned somewhat high and then gradually lowered toward the end of the stabbing process. Thus, the tubing position generally varies in the up and down direction while the tubing (108) is positioned into the hole in the injector (112) shown in FIG. 4. Once the tubing is inside the injector, the injector is powered up, and the tubing is pulled by the injector down the center between two counter-rotating chains.

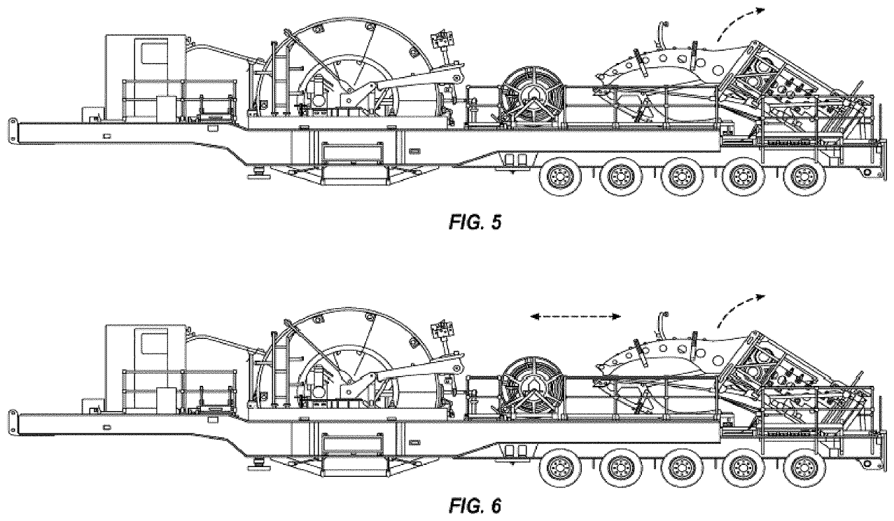

Sometimes the tubing is cut too short or the angled cut is not suitable for the tubing to be placed into the injector. In such cases often a crane or other device is employed to change the angle of the pipe, and this may further add to the potential for harm to personnel or equipment. In cases when the angles are not correct or suitable as shown in FIG. 5 and FIG. 6 the injector may be tilted up to change the angle of the tubing (108).

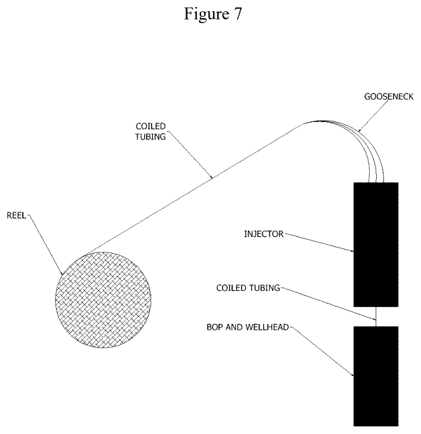

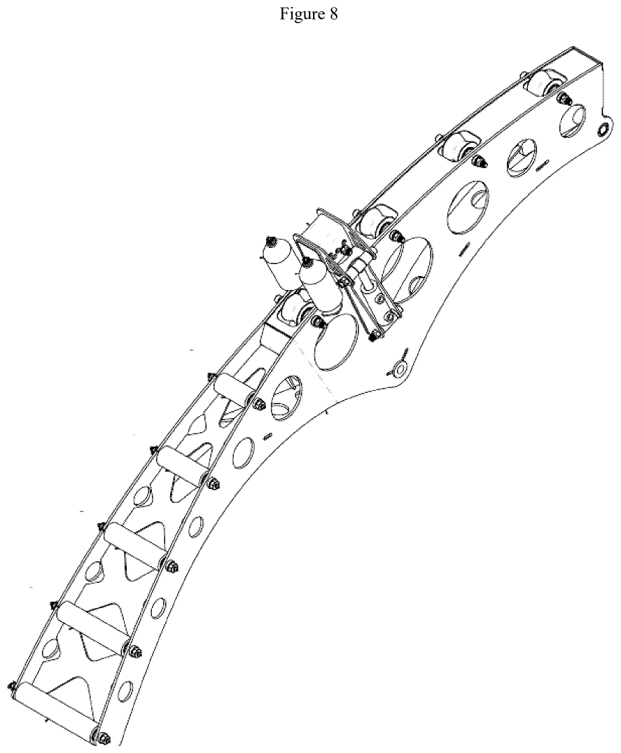

FIG. 7 shows a representative coiled tubing path from the reel over the gooseneck, i.e., tubing guide, into the injector, and into the blowout preventer (BOP) and the wellhead. FIG. 8 shows a detailed view of the tubing guide comprising the bearing retainer. As shown in FIG. 8 the tubing guide comprises a tubing guide neck and multiple lateral rollers which may comprise bearings and one or more associated retainers for containing any bearing debris within the roller assembly. The multiple lateral rollers facilitate the movement of the coiled tubing that passes over them.

The lateral rollers of the tubing guide may be made of any convenient material but generally are made with metal withstand the coiled tubing weight and/or the rugged conditions to which it may be subjected. The lateral rollers may be of various sizes and shapes so long as they facilitate the movement of the coiled tubing. As shown in FIG. 8, the first five lateral rollers preceding the arched hold down assembly near the middle of the tubing guide are cylindrical in shape and are held by a cotter pin that extends through the middle of the roller and opposing openings in the tubing guide. Nuts on each end of the cotter pin hold the pin in place while allowing the roller to rotate. As shown in FIG. 8, the lateral rollers generally decrease in length as the tubing guide narrows in near its neck.

As shown in FIG. 8 starting at about the neck near the middle of the tubing guide there are V-shaped lateral rollers located after the five lateral cylindrical shaped rollers of the tubing guide. By v-shaped it is meant that the roller comprises a groove in the center which generally be in the shape of a v or a u for securely holding the coiled tubing. The V-shaped lateral rollers may also comprise bearings and one or more associated retainers for containing any bearing debris within the roller assembly, as well as a shaft or cotter pin as described above for the lateral rollers. As shown in FIG. 8 the tubing guide assembly may also comprises vertical extending guide rollers such as the two facing one another near the arched hold down assembly that the tubing passes through. The vertical extending guide rollers assist in centering the coiled tubing as it passes over the rest of the tubing guide and heads into the injector. The vertical extending guide rollers may also comprise bearings and one or more associated retainers for containing any bearing debris within the roller assembly.

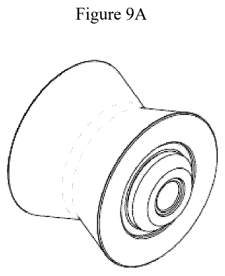

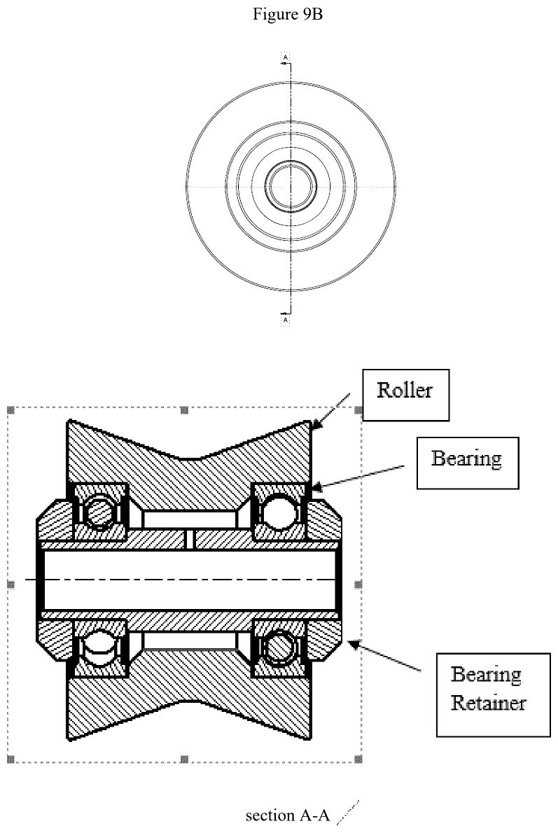

FIG. 9A shows a representative V-shaped lateral roller with the bearings and one or more bearing retainers inside the roller. FIG. 9B shows a cross-section of the V-shaped lateral roller of FIG. 9A with the bearing retainer. Advantageously, the bearing retainer prevents bearing debris due to friction, wear, or other sources within the roller assembly. The bearing retainer may be made of any suitable material and may be any shape so long as it contains a majority up to all debris within the roller assembly. In some embodiments the retainer is made of a magnetic material such it causes metal bearing debris to adhere to it. In this manner the roller assembly could still be at least partially open to the environment as the magnetic retainer's shape and location are selected so as to catch bearing debris.

### Embodiments

A roller assembly for a coiled tubing guide assembly wherein the roller assembly comprises:
a roller having an interior;
a shaft within the interior of the roller, wherein the shaft is configured to attach to a coiled tubing guide assembly while allowing the roller to roll;
one or more bearings within the interior of the roller; and
a bearing retainer configured to prevent bearing debris from leaving the roller interior.
2. The roller assembly of embodiment 1 wherein the bearing retainer is comprised of metal.
3. The roller assembly of embodiment 1 wherein the bearing retainer is comprised of a magnetic material.
4. The roller assembly of embodiment 1 wherein the roller is v-shaped.
5. A coiled tubing guide assembly comprising:
a curved frame;
a plurality of lateral cylindrical rollers configured to facilitate movement of coiled tubing thereon and wherein each lateral cylindrical roller in the plurality comprises a cotter pin extending through the middle of each roller wherein each cotter pin is configured to be affixed to the curved frame while allowing each roller to rotate; and
a roller assembly wherein the roller assembly comprises:
   a roller having an interior;
   a shaft within the interior of the roller, wherein the shaft is configured to attach to a coiled tubing guide assembly while allowing the roller to roll;
   one or more bearings within the interior of the roller; and
   a bearing retainer configured to prevent bearing debris from leaving the roller interior.
6. The coiled tubing guide assembly of embodiment 5 wherein the bearing retainer is comprised of metal.
7. The coiled tubing guide assembly of embodiment 5 wherein the roller is v-shaped.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A roller assembly wherein the roller assembly comprises:
a roller having an interior;
a shaft within the interior of the roller, wherein the shaft is configured to attach to a coiled tubing guide assembly while allowing the roller to roll;
one or more bearings within the interior of the roller; and
a bearing retainer configured to prevent bearing debris from leaving the roller interior.

2. The roller assembly of claim 1 wherein the bearing retainer is comprised of metal.

3. The roller assembly of claim 1 wherein the bearing retainer is comprised of a magnetic material.

4. The roller assembly of claim 1 wherein the roller is v-shaped.

5. A coiled tubing guide assembly comprising:
a curved frame;
a plurality of lateral cylindrical rollers configured to facilitate movement of coiled tubing thereon and wherein each lateral cylindrical roller in the plurality comprises a cotter pin extending through the middle of each roller wherein each cotter pin is configured to be affixed to the curved frame while allowing each roller to rotate; and
a roller assembly wherein the roller assembly comprises:
a roller having an interior;
a shaft within the interior of the roller, wherein the shaft is configured to attach to a coiled tubing guide assembly while allowing the roller to roll;
one or more bearings within the interior of the roller; and
a bearing retainer configured to prevent bearing debris from leaving the roller interior.

6. The coiled tubing guide assembly of claim 5 wherein the bearing retainer is comprised of metal.

7. The coiled tubing guide assembly of claim 5 wherein the roller is v-shaped.
